(19) United States
(12) Patent Application Publication
(10) Pub. No.: US 2005/0187052 A1
(43) Pub. Date: Aug. 25, 2005

(54) Adjusting device of belt tension

(76) Inventor: Yasuhiro Yokoyama, Kawasaki-shi (JP)

Correspondence Address: JACOBSON HOLMAN PLLC, 400 SEVENTH STREET N.W., SUITE 600, WASHINGTON, DC, 20004, US

(21) Appl. No.: 11/048,058

(22) Filed: Feb. 2, 2005

(30) Foreign Application Priority Data
Feb. 3, 2004 (JP) 2004-27183

(51) Int. Cl. F16H 7/14; F16H 7/12

(52) U.S. Cl. 474/117; 474/133; 474/135

(57) ABSTRACT

A belt tension adjusting device composed to ease positive detection of plastic elongation of belt is proposed. The time for the belt to be replaced by new one can be recognized in early stages and accurately. The plastic elongation of the belt can be detected visually from the front or upper side of an engine without unsighted by the auto-tensioner (automatic belt tension adjuster) and the belt. Further, workability of replacing belt is improved.

The device comprises a crank pulley (1), accessory drive pulleys, a belt looped over the pulleys, a tension pulley (5), an actuator (32), a connecting arm (8), an auto-tensioner (3) for adjusting belt tension automatically, an indicating member which is attached to the moving end of the actuator (32) to move in conjunction with the moving end, and an detecting member for detecting the position of the indicating member, whereby the plastic elongation of belt can be estimated by detecting the position of the indicating member visually.

### BACKGROUND OF THE INVENTION

1. Field of the Invention

The present invention relates to a belt tension adjusting device to be applied to an engine mounted on a vehicle, etc., the device comprising an accessory drive pulley connected to a crank pulley of an engine by means of a belt, a tension pulley for adjusting the tension of the belt, and an auto-tensioner (automatic belt tension adjuster) for adjusting belt tension by changing the position of rotation center of the tension pulley by means of an actuator.

2. Description of the Related Art

As for belt transmission for driving accessories of an engine, belt tension adjusting devices are disclosed for example in JP11-82652A, JP11-8100851A, JP2002-323101A and JP2003-27953A. The device having a tension pulley for adjusting the tension of the belt and an auto-tensioner (automatic belt tension adjuster) which is composed such that the position of rotation center of the tension pulley is moved by shifting the moving end of an actuator, the moving end being connected to the tension pulley by means of a connecting arm. According to these belt tension adjusting devices, belt tension is automatically adjusted, but how much the center of the tension pulley is moved for adjusting the tension of the belt can not be detected.

In FIGS. 10˜12 is shown an example of belt tension adjusting device of prior art for bus engine, which comprises a tension pulley and auto-tensioner, and with which the amount of shift of the center of the tension pulley can be detected. FIG. 10 is a side view along the crankshaft center line, FIG. 11 is an elevation viewed in the direction of the crankshaft center line, and FIG. 12 is an elevational view of the tension pulley and auto-tensioner.

In the drawings, reference numeral 105 is an engine, 100 is a radiator, 102 is a radiator fan, 101 is a shroud covering said radiator fan 102, 103 is an alternator, 104 is a compressor for an air conditioner, and 106 is the crankshaft center line of the engine 105.

Reference numeral 1 is a crank pulley fixed to the crankshaft of said engine 105, 107 is an air conditioner pulley fixed to the rotation shaft of said compressor 104 for air conditioner, 4 is an alternator pulley fixed to the rotation shaft of said alternator 103, and 108 is a water pump pulley fixed to the rotation shaft of a water pump (not shown in the drawings).

Reference numeral 5 is a tension pulley. Reference numeral 2 is a belt looped over said crank pulley 1, water pump pulley 108, air conditioner pulley 107, alternator pulley 4, and tension pulley 5. Torque is transmitted from said crank pulley 1 to said water pump pulley 108, air conditioner pulley 107, and alternator pulley 4 by means of said belt 2 to drive accessories such as said water pump (not shown in the drawings), compressor 104 for air conditioner, alternator 103, etc.

Reference numeral 3 is an auto-tensiner (automatic belt tension adjuster) for adjusting the tension of said belt 2. Reference numeral 15 is a supporting shaft to support said auto-tensioner, 32 is an actuator, 7 is an auto-tensiner connecting shaft connected to the moving end of said actuator 32, and 8 is a connecting arm for connecting the auto-tensioner connecting shaft 7 at the moving end of the actuator 32 to a tension pulley supporting shaft 13 supporting said tension pulley 5 for rotation. The connecting arm 8 is supported for rocking by a supporting shaft 6 attached to said engine 105.

The tension of said belt 2 can be adjusted by moving the moving end of the actuator 32 of said auto-tensioner 3. When the auto-tensioner connecting shaft 7 connected to the moving end of the actuator 32 of the auto-tensioner 3 is shifted by operating the actuator 32, the connecting arm 8 is turned around the center of the supporting shaft 6, whereby the position of the tension pulley supporting shaft 13 and the tension pulley 5 supported by the tension pulley supporting shaft 13 is changed to allow the tension of the belt 2 to be adjusted.

Reference numeral 110 is a pointer fixed to the connecting arm 8, and 111 is a scale plate fixed to the engine 105. As the pointer 110 turns together with the connecting arm and the scale plate is fixed to the engine, how much the connecting arm 8 is turned relative to the engine can be visually detected by means of the pointer 110 and scale plate 111. Thus, the travel of the center of said tension pulley 5, which is a barometer to show how much the belt elongated plastically, can be visually detected. According to this prior art, the pointer 110 attached to the connecting arm 8 protrudes from the arm and the rotated angle of the connecting arm is detected by finding the position of the tip of the pointer 100 which vibrates relatively violently due to engine vibration, and the tip of the pointer 110 and the scale plate 111 is positioned where it is not easy to inspect visually due to the presence of the actuator 32 as shown in FIG. 11.

### SUMMARY OF THE INVENTION

The object of the present invention is to provide a belt tension adjusting device for an engine, with which plastic elongation of belt can be detected positively and accordingly the time for the belt to be replaced by new one is detected accurately in early stages, and with which plastic elongation of belt can be detected visually easily from the upper side or front side of the engine without unsighted by the auto-tensioner (automatic belt tension adjuster) and/or the belt.

To attain the object mentioned above, the present invention proposes a belt tension adjusting device comprising: a crank pulley; an accessory pulley or pulleys; a belt looped over said pulleys to transmit the torque of said crank pulley to said accessory pulley or pulleys for driving an accessory or accessories; a tension pulley pushing the belt to give tension to the belt; an auto-tensioner (automatic belt tension adjuster) for adjusting belt tension automatically, the auto-tensioner comprising an actuator and a connecting arm, a fixing end of said actuator being supported by a supporting shaft attached to the body of the engine, a moving end of said actuator being connected to an end part of said connecting arm, the tension pulley being supported for rotation at the other end part of the connecting arm, the connecting arm being supported for rocking by a supporting shaft attached to the body of the engine at an intermediate position between both ends of the connecting arm so that the rotation center of said tension pulley being able to be shifted by the travel of the moving end of said actuator to adjust belt tension; an indicating member attached to the moving end of said actuator so that the indicating member moves in conjunction with said moving end; a detecting member for finding the position of said indicating member; whereby the state of stretch of the belt (i.e. the plastic elongation of the belt) is judged through detecting the position of said indicating member by said detecting member.

According to the invention, the device is composed such that the state of stretch of the belt (plastic elongation of the belt) is judged by detecting the position of the indicating member which moves as plastic elongation of belt increases because belt tension is adjusted automatically. Therefore, plastic elongation of belt can be estimated relatively accurately by detecting the amount of the shift of the moving end of the actuator, and the time for the belt to be replaced can be judged accurately in early stages. (Of course, the amount of the shift of the moving end of the actuator is influenced not only by the plastic elongation of the belt, but by the wear of the pulleys and belt, direction of the shift of the tension pulley, and spring force of the actuator which varies as the amount of the shift varies. However, the elastic elongation can be estimated relatively accurately by the amount of the shift of the moving end of the actuator.)

In the invention, it is preferable that said indicating member is a bar-like member extending in the direction of the axis of said actuator with an end thereof connected to the moving end of said actuator, the protrusion length of the other end of the indicating member protruding from said detecting member is detected, whereby it is judged that the plastic elongation of the belt has reached the maximum permissible value when said protrusion length has reached the maximum permissible length.

With this composition, as the plastic elongation of the belt can be estimated by detecting the protruding length of the bar-like indication member located along the side of the auto-tensioner, the amount of shift of the moving end of the actuator can be detected visually from the front side of the engine without unsighted by the auto-tensioner and/or the belt.

The plastic elongation of the belt can be estimated from the amount of shift of the moving end of the actuator, accordingly from the position of the indicating member. Thus, the plastic elongation is easily and accurately judged visually by means of the bar-like member.

It is also preferable that said detecting member is a scale or gradation marks provided in the vicinity of the moving end of said actuator so that the amount of shift of said indication member can be detected.

By composing like this, the amount of shift of the moving end of the actuator can be perceived visually and easily without unsighted by the actuator.

It is also preferable that a belt life limit range is indicated on said detecting member to indicate the permissible limit of plastic elongation of belt. By this, the time for the belt to be replaced can be easily judged by visual inspection only by detecting that the position of said indicating member comes in said belt life limit range.

It is also preferable that said indicating member is a bar-like member extending in the direction of the axis of said actuator with an end thereof connected to the moving end of said actuator and with the other end part provided with an indicating part, said detecting member is a scale member attached to the fixing end of said actuator and has graduation marks formed thereon to detect the position of said indicating part.

With this composition, the plastic elongation of the belt can be detected by means of said indication member located near the top of the bar-like member which moves in conjunction with the moving end of the actuator and the scale member attached to the fixing end located at the upper part of the actuator, so that the plastic elongation of the belt can be detected visually easily from the upper side of the engine without unsighted by the auto-tensioner and/or the belt.

It is also preferable that said indicating member is an indicating part provided on the moving end of said actuator and said detecting member is a scale member attached to said connecting arm to detect the position of said indicating part.

With this composition, as the indicating part and scale member are located at the actuator's moving end side which faces to the front side of the engine, the indication part and scale are viewable from the front side of the engine, and as the scale member is attached on the surface of the connecting arm, the scale member can be attached with ease.

Further, as said indicating member is attached to the moving end of the actuator, the amount of shift of the indicating member is large and visibility is good.

It is preferable that said indicating member and detecting member are located in a position near to an inspection door provided in a rear part of the floor of a rear engine bus. By this, the indicating part and scale can be easily inspected visually through the inspection door provided on the floor in the rear part of the vehicle.

### BRIEF DESCRIPTION OF THE DRAWINGS

FIG. 1 is an elevational view of the first embodiment of the belt tension adjusting device of an engine for a bus according to the present invention.

FIG. 2 is a sectional side view of the auto-tensioner.

FIG. 3 is a partial elavational view of the second embodiment of the device showing the tension pulley and auto-tensioner.

FIG. 4 is a view of the third embodiment corresponding to FIG. 3.

FIG. 5 is a view of the fourth embodiment corresponding to FIG. 3.

FIG. 6 is a view of the fifth embodiment corresponding to FIG. 3.

FIG. 7(A) is a view of the sixth embodiment corresponding to FIG. 3, and FIG. 7(B) is a sectional view showing the state the stopper is inserted.

FIG. 8 is a view of the seventh embodiment corresponding to FIG. 3.

FIG. 9 is a view of the eighth embodiment corresponding to FIG. 3.

FIG. 10 is a side view of an example of belt tension adjusting device of prior art.

FIG. 11 is an elevational view of the device shown in FIG. 10.

FIG. 12 is an elevational view of the tension pulley and auto-tensioner of the device shown in FIG. 10.

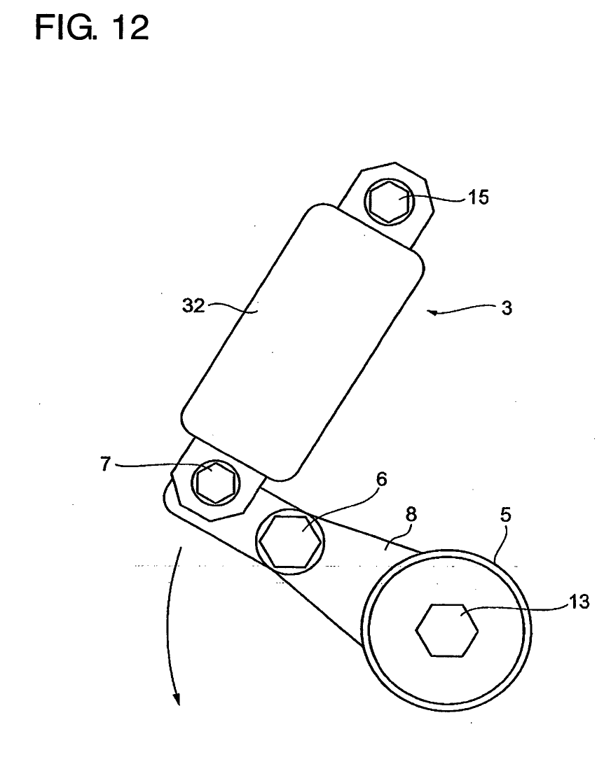

### DETAILED DESCRIPTION OF THE PREFERRED EMBODIMENTS

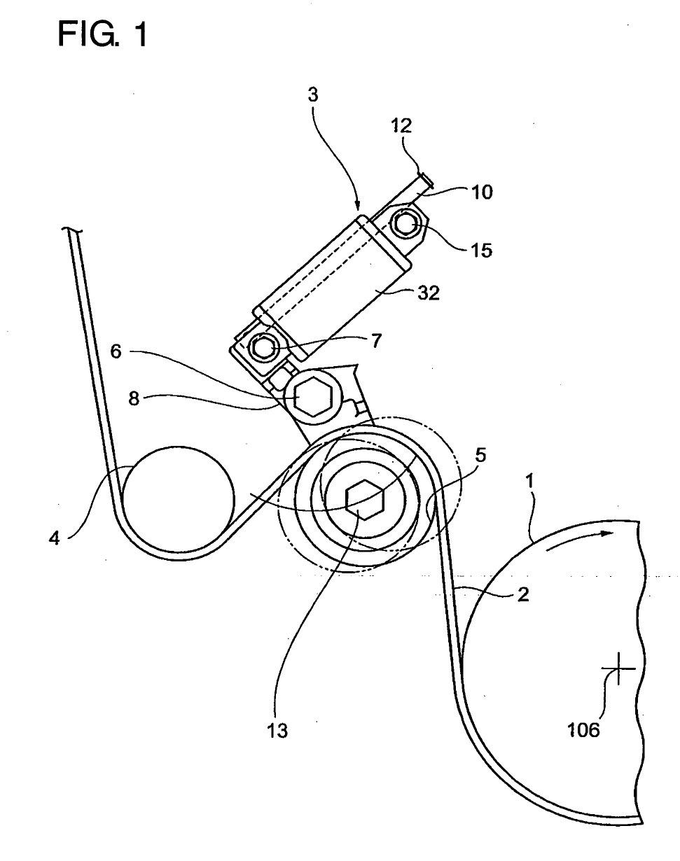

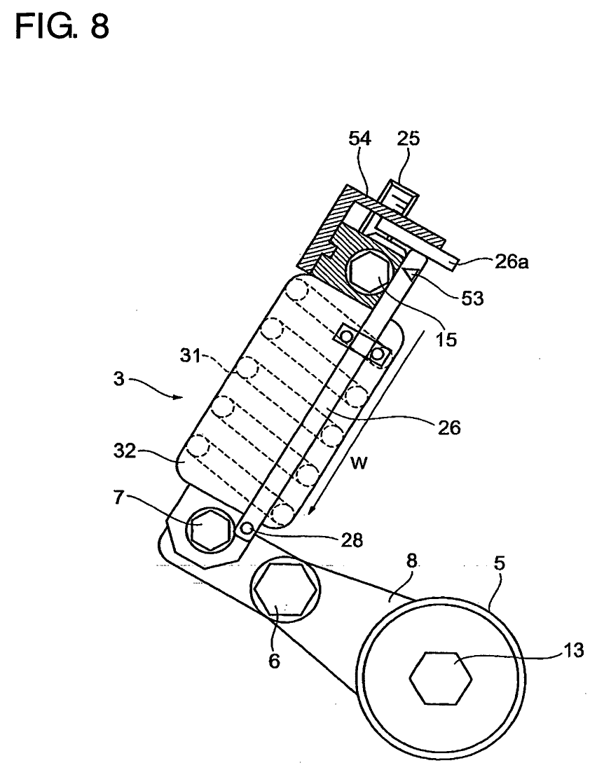

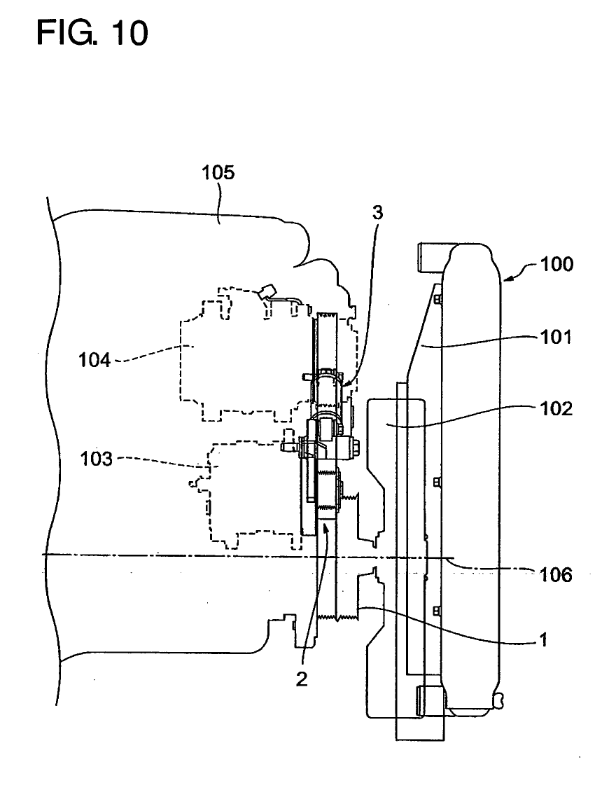

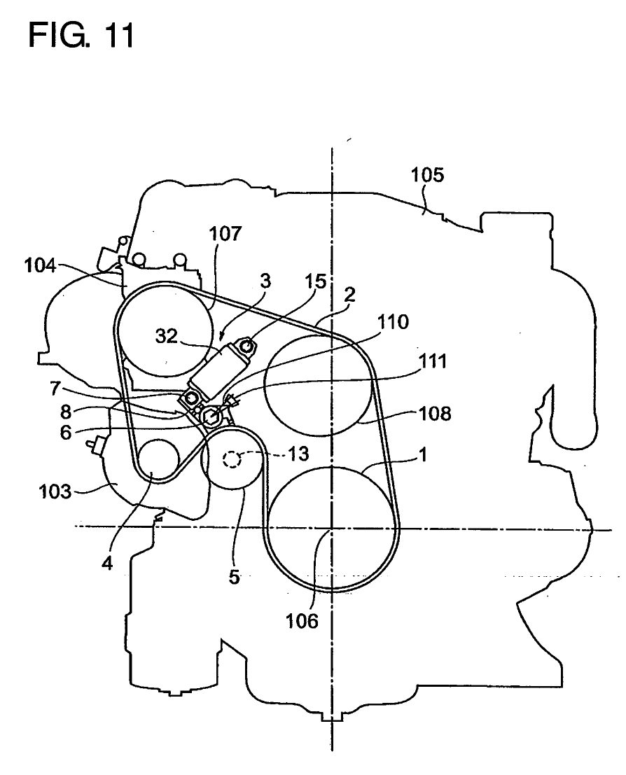

Referring to FIGS. 1˜FIG. 8 showing the first to seventh embodiment, the configuration and arrangement of an engine 105, radiator 100, radiator fan 102, shroud 101 for covering the radiator, alternator 103, compressor 104 for an air conditioner, crank pulley 1 fixed to the crankshaft of said engine 105, air conditioner pulley 107 fixed to the rotation shaft of said compressor 104 for air conditioner, alternator pulley 4 fixed to the rotation shaft of said alternator 103, water pump pulley 108 fixed to the rotation shaft of a water pump (not shown in the drawings), tension pulley 5, etc. and the configuration and arrangement of a belt 2 looped over said crank pulley 1, water pump pulley 108, air conditioner pulley 107, alternator pulley 4, and tension pulley 5 are similar to the prior art shown in FIGS. 10 and 11.

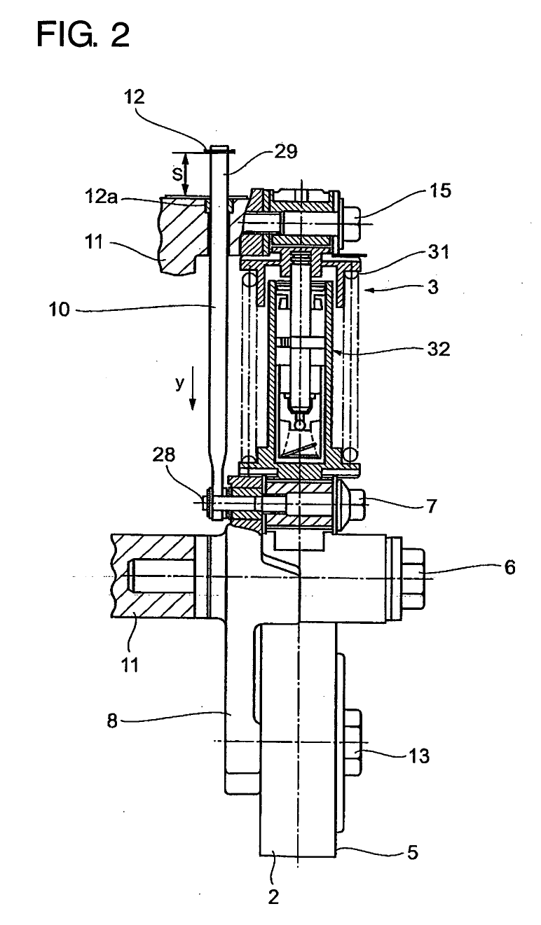

In FIG. 1 and FIG. 2 showing the first embodiment, reference numeral 1 is a crank pulley, 4 is an alternator pulley, 2 is a belt looped over said crank pulley 1, water pump pulley 108 (see FIG. 11), air conditioner pulley 107 (see FIG. 11), alternator pulley 4, and tension pulley 5. Torque is transmitted from said crank pulley 1 to said water pump pulley 108, air conditioner pulley 107, and alternator pulley 4 by means of said belt 2 to drive accessories such as said water pump (not shown in the drawings), compressor 104 for air conditioner (see FIG. 10), alternator 103 (see FIG. 10), etc. Reference numeral 106 is the crankshaft center line of the engine 105.

Reference numeral 3 is an auto-tentioner (automatic belt tension adjuster) for adjusting the tension of the belt 2, 32 is an actuator of the auto-tensioner 3. Reference numeral 15 is an auto-tensioner supporting shaft to support the fixing end of the actuator 32, said auto-tensionar 3 being fixed to the body part 11 of said engine (see FIG. 11) by the supporting shaft 15. Reference numeral 7 is an auto-tensioner connecting shaft attached to the moving end of said actuator 32. Reference numeral 13 is a tension pulley supporting shaft which supports said tension pulley 5 for rotation.

Reference numeral 8 is a connecting arm, which is supported by a supporting shaft 6 attached to the body part 11 of the engine at a center part thereof to be capable of rocking motion and which supports said auto-tensioner connecting shaft 7 at an end thereof and said tension pulley supporting shaft 13 at the other end thereof so that the movement of the moving end of said actuator 32 is transmitted to change the center position of said tension pulley 5.

When the belt 2 elongates plastically, which induces a reduction in belt tension, the moving end of the actuator 3 and accordingly the auto-tensioner connecting shaft 7 is shifted by the spring force of a spring 31 in the auto-tensioner 3 by a length corresponding to the reduction in the belt tension. Said connecting arm 8 is turned around the center of the supporting shaft 6 by the shift of the auto-tensioner connecting shaft 7, and said tension pulley supporting shaft 13 and accordingly the tension pulley 5 supported by the tension pulley supporting shaft 13 is shifted to adjust the tension of the belt 2. In this way, the tension of the belt 2 is corrected automatically.

Reference numeral 10 is a guide rod which serves as a pointer member for indicating the travel of the auto-tensioner connecting shaft 7 attached to the moving end of the actuator 32. The guide rod 10 is disposed outside the actuator 32 along the axial direction thereof with an end of the rod connected to an end of the auto-tensioner connecting shaft 7 as shown in FIG. 2 so that the rod 10 is moved in conjunction with the movement of the moving end of the actuator 32. The guide rod 10 is located outside the auto-tensioner 3 at a position near toward the upper side of engine, and the other end side of the rod is fitted slidably to a bush 12a fitted tightly to the body part 11 of the engine, the end face of the bush 12a being a detecting member. Reference numeral 12 is a stopper attached to the top end part of the guide rod 10.

According to the first embodiment, when the moving end of the actuator 32 of the auto-tensioner 3, accordingly the auto-tentioner connecting shaft 7 shifts due to a plastic elongation of the belt and the tension pulley 5 supported by the tension pulley supporting shaft 13 is shifted as mentioned above, the guide rod 10 connected to the auto-tensioner connecting shaft 7 is moved in the direction indicated by arrow y in FIG. 2, and protruding length s of the guide rod protruding from the end face of the bush 12a decreases.

When said protrusion length s decreases to zero and the stopper 12 attached to the top end part of the guide rod 10 contacts the end face of the bush 12a, it is judged that the plastic elongation of the belt 2 has reached the maximum limit and the belt 2 should be replaced by new one.

Therefore, according to the first embodiment, a change in protruding length s of the guide rod 10 from the end face of the bush 12a (detecting member) located outside the auto-tensioner 3 at a position near toward the upper side of engine, that is, a change in protruding length from the engine body is detected and it is judged that the plastic elongation of the belt has reached the maximum limit, i.e. the time for the belt to be replaced has reached when said protruding length s becomes zero and the stopper 12 contacts the end face of the bush 12a, so that the travel of the moving end of the actuator 32, accordingly changes in plastic elongation can be detected from the front side of the engine by observing the guide rod without unsighted by the auto-tensioner 3 and the belt 2.

As the belt tension adjusting device of the invention is composed such that the travel of the guide rod 10 connected to the auto-tensioner connecting shaft 7 which is attached to the moving end of the actuator 32 of the auto-tensioner 3 is detected by the protruding length s of the guide rod 10 to judge the stretched state of the belt 2, an increase in plastic elongation of the belt which induces a reduction in belt tension can be accurately detected, because the shift of the moving end of the actuator 32 in correspondence with the plastic elongation of the belt is relatively large. Therefore, with this configuration, it is possible to recognize the stretched state of the belt 2 (plastic elongation of the belt 2) and the time for the belt 2 to be replaced in early stages and accurately.

Further, as the travel of the moving end of the actuator 32, accordingly the stretched state of the belt and changes in plastic elongation of the belt, can be detected from the front side of the engine without unsighted by the auto-tensioner 3 and belt 2 by means of the guide rod 10, visibility and also accuracy of detecting changes in plastic elongation of the belt can be improved.

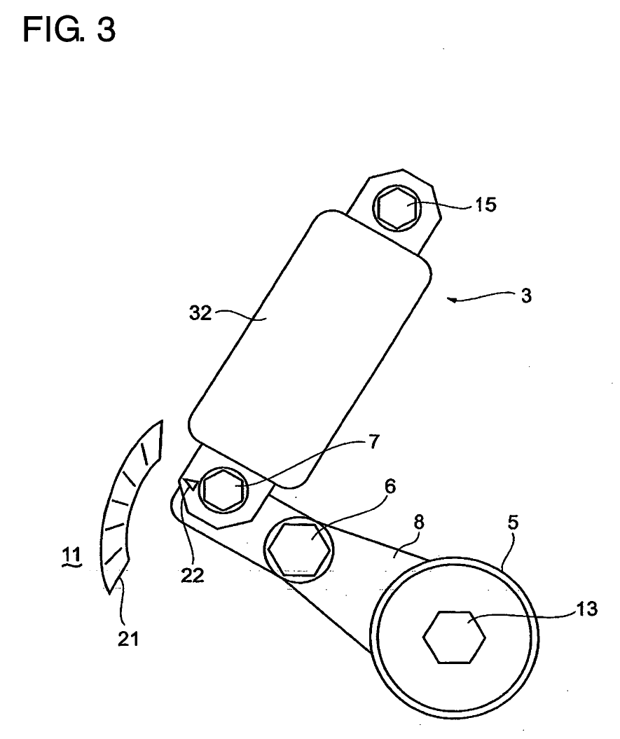

The second to seventh embodiments shown in FIGS. 3 to 8 are similar in composition to the device of the first embodiment except that the guide rod 10 as an indicating member and the bush 12a fixed to the engine body as a detecting member are replaced by members as described in the following.

In FIG. 3 showing the third embodiment, a pointer 22 which is an indicating member is fixed to the moving end of the actuator 32 near the auto-tensioner connecting shaft 7 and a scale plate 21 is provided to the engine body 11, the pointer 22 and scale plate 21 being shaped to be easy for visual observation, so that the travel of the pointer 22 can be determined by the scale plate 21.

According to the second embodiment, as the pointer 22 and the scale plate 21 are located at the position where the travel of the moving end of the actuator 32 is large and visual evaluation thereof is easy, the visual determinability of plastic elongation of the belt 2 is improved and it becomes possible to predict the time for the belt to be replaced.

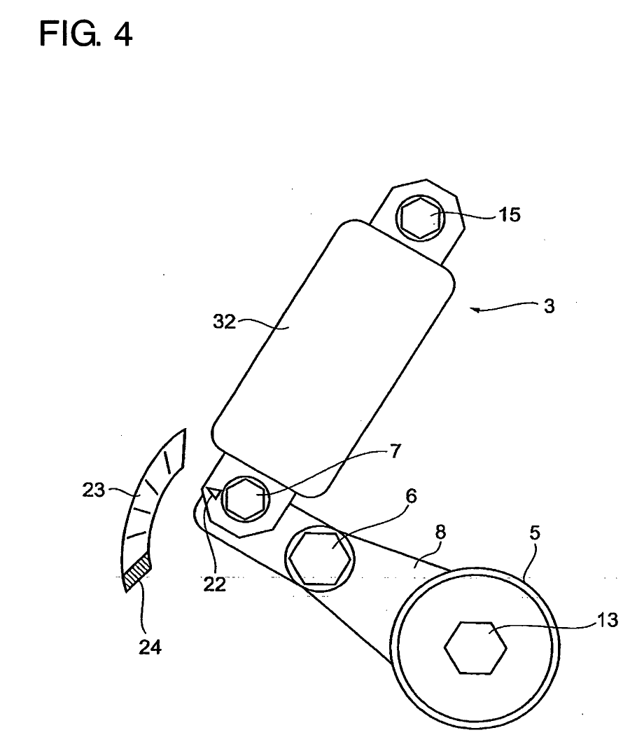

In FIG. 4 showing the third embodiment, the pointer 22 which is an indicating member is fixed to the moving end of the actuator 32 near the auto-tensioner connecting shaft 7 as is the case with the first embodiment, and a scale plate 23 on which is marked a belt life limit range 24 is provided to the engine body so that the travel of the pointer 22 can be determined by the scale plate 23.

According to the third embodiment, it is judged that the life of the belt has expired when the pointer 22 reaches the belt life limit range, and the time for the belt 2 to be replaced can be judged visually easily only by detecting that the pointer 22 points to the belt life limit range indicated on the scale plate 23.

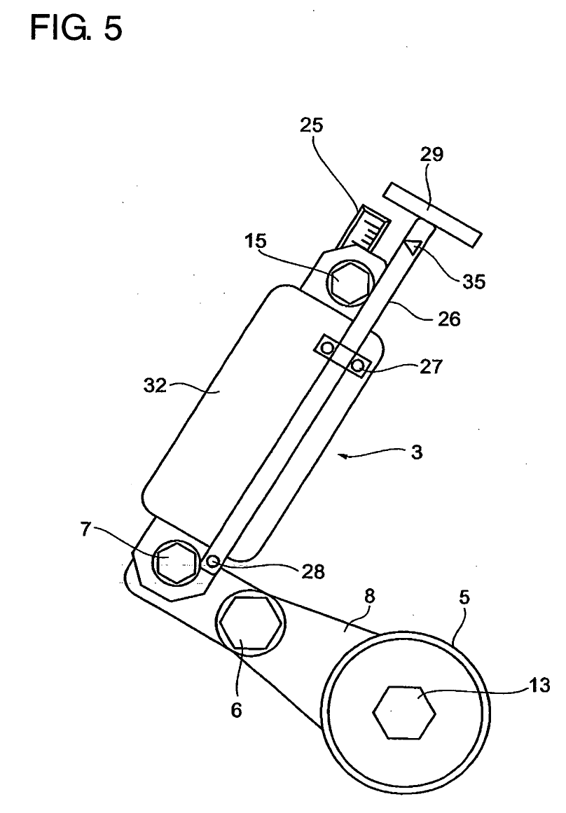

In FIG. 5 showing the fourth embodiment, reference numeral 26 is a bar-like indicating member extending along the axial direction of the actuator 32 with an end of the indicating member 26 fixed to the moving end of the actuator 32 near the auto-tensioner connecting shaft 7 so that the indicating member 26 is movable together with the moving end of the actuator 32. A pointer 35 which is a pointing part is provided in the top end part of the indicating member 26. Reference numeral 27 is a supporting member for supporting the intermediate portion of the indicating member 26 so that the member 26 can move in the axial direction of the actuator 32.

Reference numeral 25 is a scale member fixed to the fixing end of the actuator 32 and having graduation marks formed thereon.

According to the fourth embodiment, the plastic elongation of the belt 2 can be detected by means of the pointer 35 provided in the top end part of the bar-like indicating member 26 which moves in conjunction with the moving end of the actuator 32 and the scale member 25 attached to the fixing end provided at the upper part of the actuator 32, so the plastic elongation of the belt 2 can be detected, the visual determinability of plastic elongation of the belt 2 is improved, and it becomes possible to predict the time for the belt to be replaced.

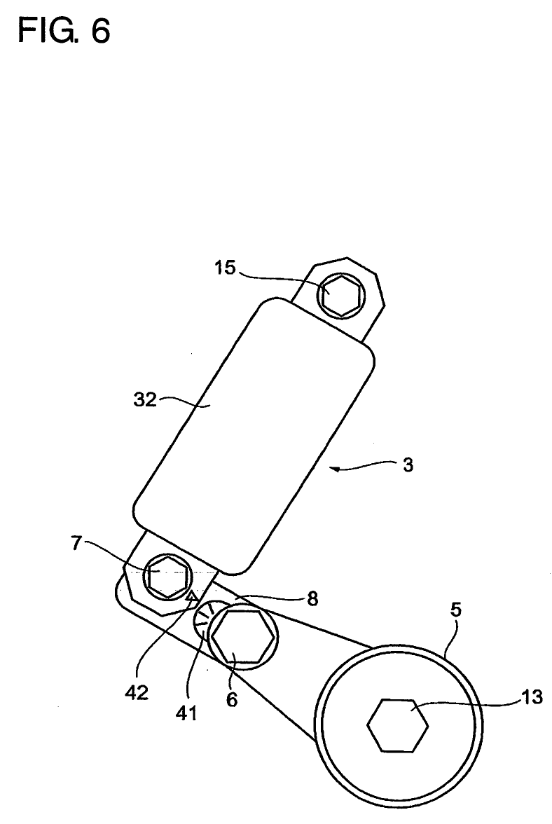

In FIG. 6 showing the fifth embodiment, reference numeral 42 is a pointer which is an indicating part fixed to the moving end of the actuator 32, 41 is a scale member attached to the connecting arm 8 so that the travel of the pointer 42 can be determined by the scale plate 41.

According to the fifth embodiment, as the pointer 42 and the scale member 41 are located at a position where the travel of the moving end of the actuator 32 is large, visibility is improved, and as the scale member 41 is attached to the surface of the connecting arm 8, it is easy to attach the scale member 41.

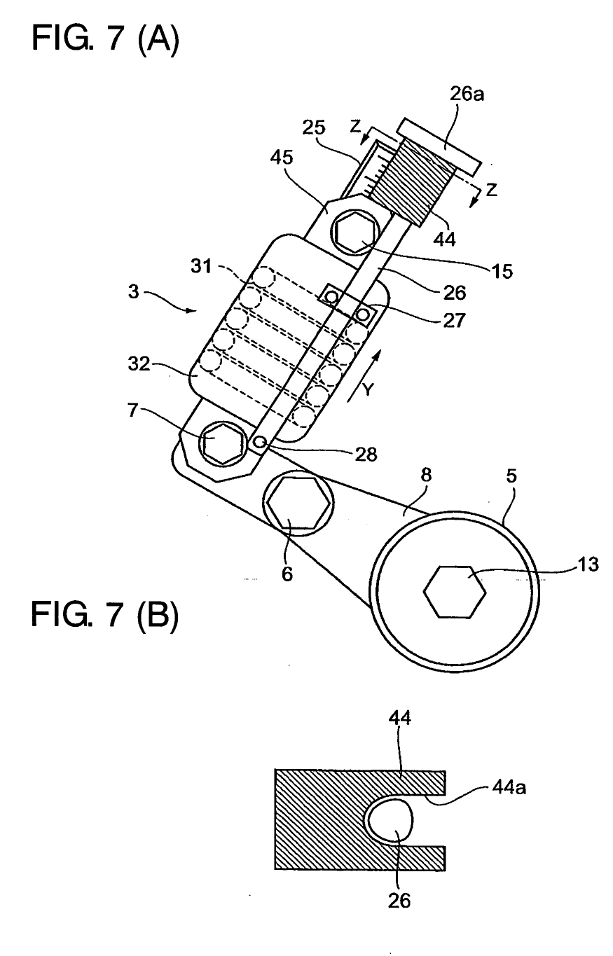

In FIG. 7(A) showing the sixth embodiment, reference numeral 26 is a bar-like indicating member extending along the axial direction of the actuator 32 with an end of the indicating member 26 fixed to the moving end of the actuator 32 near the auto-tensioner connecting shaft 7 so that the indicating member 26 is movable together with the moving end of the actuator 32. In the top end part of the indicating member 26 is provided a pointer (not shown in the drawing). Reference numeral 27 is a supporting member for supporting the intermediate portion of the indicating member 26 so that the member 26 can move in the axial direction of the actuator 32.

Reference numeral 25 is a scale member fixed to the fixing end of the actuator 32 and having graduation marks formed thereon.

Reference numeral 44 is a stopper. The stopper 44 has a groove 44a as shown in FIG. 7(B) and can be inserted between the top end surface of the fixing end 45 of the actuator 32 and the undersurface of the flange 26a formed at the top end of the indicating member 26, the indicating member 26 passing through the groove 44a of the stopper 44 when it is inserted. By inserting the stopper, the moving end of the actuator is moved upward and the tension pulley 5 is moved downward, whereby the belt 2 is slackened.

According to the sixth embodiment, the actuator 32 is locked in a contracted state in which the moving end of the actuator is moved against the spring force of the spring 31 in the direction indicated by arrow Y by inserting the stopper 44 between the fixing end 45 of the actuator 32 and the flange 26a of the indicating member 26. By locking the actuator 32 in the contracted state, the pushing force of the tension pulley 5 pushing the belt 2 is removed to relax the tension of the belt 2, and the belt 2 can be easily replaced by new one without necessity of using any force to resist the belt tension because the belt is slackened, therefore workability of replacing belt is improved.

In FIG. 8 showing the seventh embodiment, the device is composed such that the actuator 32 can be locked in an extended state as against the case of the sixth embodiment in which the actuator 32 is locked in a contracted state. Other than this, the seventh embodiment is composed the same as the sixth embodiment shown in FIG. 7.

In FIG. 8, reference numeral 54 is a stopper used when locking the actuator in an extended state. The stopper 54 is attached to the fixing end of the actuator 32 by engaging a protrusion formed on an inner side of the stopper 54 with a groove formed on a side of the fixing member of the actuator 32. The top part of the stopper 54 contacts the top surface of the flange 26a formed at the top of the indicating member 26. This embodiment is applied when the belt is slackened by locking the actuator in an extended state.

According to the seventh embodiment, the actuator 32 is locked in an extended state in which the moving end of the actuator is moved in the direction indicated by arrow Y pushed by the spring force of the spring 31 by attaching the stopper 54 so that the top part thereof contacts the top surface of the indicating member 26. By locking the actuator 32 in the extended state, the pushing force of the tension pulley 5 pushing the belt 2 is removed to relax the tension of the belt 2, and the belt 2 can be easily replaced by new one without necessity of using any force to resist the belt tension because the belt is slackened, and workability of replacing belt is improved.

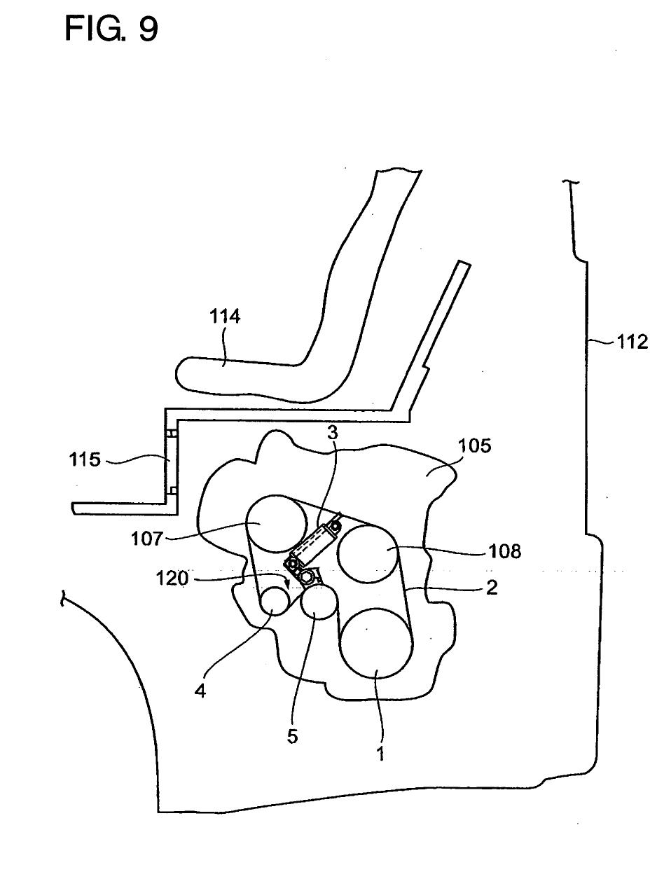

In the eighth embodiment shown in FIG. 9, the belt tension adjusting device of the first to seventh embodiment is located in the rear part of the vehicle body, where an inspection door 115 is provided, of a rear engine bus. As the belt tension adjusting device of the first to seventh embodiment is composed so that the travel of the moving end of the actuator is perceived visually, the travel can be inspected easily through the inspection door 115.

In FIG. 9, reference numeral 1 is a crank pulley, 108 is a water pump pulley, 107 is an air conditioner pulley, 4 is an alternator pulley, 5 is a tension pulley, and 2 is a belt looped over the pulleys.

1. A belt tension adjusting device for an engine comprising:
a crank pulley,
an accessory pulley or pulleys,
a belt looped over said pulleys to transmit the torque of said crank pulley to said accessory pulley or pulleys for driving an accessory or accessories,
a tension pulley pushing the belt to give tension thereto,
an auto-tensioner (automatic belt tension adjuster) for adjusting belt tension automatically, the auto-tensioner comprising an actuator and a connecting arm, a fixing end of said actuator being supported by a supporting shaft attached to the body of the engine, a moving end of said actuator being connected to an end part of said connecting arm, the tension pulley being supported for rotation at the other end part of the connecting arm, the connecting arm being supported for rocking by a supporting shaft attached to the body of the engine at an intermediate position between both ends of the connecting arm so that the rotation center of said tension pulley being able to be shifted by shifting the moving end of the actuator to adjust the tension of the belt,
an indicating member attached to the moving end of the actuator so that the indicating member moves in conjunction with said moving end,
a detecting member for finding the position of said indicating member;
whereby the state of stretch of the belt (i.e. the plastic elongation of the belt) is judged through detecting the position of said indicating member by said detecting member.

2. The belt tension adjusting device according to claim 1, wherein said indicating member is a bar-like member extending in the direction of the axis of said actuator with an end thereof connected to the moving end of said actuator, the protrusion length of the other end of the indicating member protruding from said detecting member is detected, whereby it is judged that the plastic elongation of the belt has reached the maximum permissible value when said protrusion length has reached the maximum permissible length.

3. The belt tension adjusting device according to claim 1, wherein said indicating member is a bar-like member extending in the direction of the axis of said actuator with an end thereof connected to the moving end of said actuator and with the other end side guided by said detecting member provided in the vicinity of the fixing end of said actuator, the protrusion length of the other end of the bar-like member protruding from said detecting member is detected, whereby it is judged that the plastic elongation of the belt has reached the maximum permissible value when said protrusion length has reached the maximum permissible length.

4. The belt tension adjusting device according to claim 1, wherein said indicating member is a bar-like member extending in the direction of the axis of said actuator with an end thereof connected to the moving end of said actuator and with the other end part provided with an indicating part, said detecting member is a scale member attached to the fixing end of said actuator and has graduation marks formed thereon to detect the position of said indicating part.

5. The belt tension adjusting device according to claim 1, wherein said detecting member is a scale or gradation marks provided near the moving end of said actuator for detecting the position of the indicating member provided to said moving end.

6. The belt tension adjusting device according to claim 1, wherein a belt life limit range is indicated on said detecting member to show the permissible limit of plastic elongation of belt.

7. The belt tension adjusting device according to claim 1, wherein said indicating member is an indicating part provided on the moving end of said actuator and said detecting member is a scale member attached to said connecting arm to detect the position of said indicating part.

8. The belt tension adjusting device according to claim 1, wherein said indicating member and detecting member are located in a position near to an inspection door provided in a rear part of the floor of a rear engine bus.

9. The belt tension adjusting device according to claim 2, wherein said indicating member is formed to have a flange part so that a stopper member can be inserted between said flange part and the fixing end of said actuator in order to make it possible to replace easily the belt by new one by locking the telescopic travel of said moving end and allowing the pushing force of said tension pulley pushing the belt to be released.
